(19) United States
(12) Patent Application Publication
(10) Pub. No.: US 2011/0052944 A1
(43) Pub. Date: Mar. 3, 2011

(54) DEVICE FOR HEATING A RECHARGEABLE BATTERY, CHARGER, AND ACCESSORY ELEMENT

(76) Inventors: Wolf MATTHIAS, Stuttgart (DE); Jochen Bertsch, Muehlacker-Grosslattbach (DE); Cornelius Liebenow, Leinfelden-Echterdingen (DE)

(21) Appl. No.: 12/874,383

(22) Filed: Sep. 2, 2010

(30) Foreign Application Priority Data
Sep. 2, 2009 (DE) 10 2009 029 093.1

(51) Int. Cl. H01M 10/44; H02J 7/00; H01R 13/66

(52) U.S. Cl. 429/50; 320/107; 439/620.01

(57) ABSTRACT

The invention relates to a method for heating a rechargeable battery in which the rechargeable battery is supplied with voltage in such a way that the current flowing in the rechargeable battery heats the rechargeable battery without essentially charging the rechargeable battery. The invention also relates to a charger for carrying out the method.

### CROSS-REFERENCE TO RELATED APPLICATION

This application is based on German Patent Application 10 2009 029 093.1 filed Sep. 2, 2009.

### BACKGROUND OF THE INVENTION

1. Field of the Invention

The invention relates to a device for heating a rechargeable battery, a charger, and an accessory element.

2. Description of the Prior Art

Various embodiments for charging a rechargeable battery are known from the prior art. For example, the U.S. Pat. No. 7,270,910 B2 describes a charger for a rechargeable battery in which the charger takes into account the temperature of the rechargeable battery during the charging of the rechargeable battery. The cited patent also describes the fact that a rechargeable battery must be heated before it is charged if the temperature of the rechargeable battery is too low.

DE 20 2008 010 458 U1 has also disclosed a device for operating the electrical drive unit. The electrical drive unit is supplied with current by means of a rechargeable battery embodied in the form of rechargeable cells. In addition, a temperature sensor is provided; the electrical power requested by the drive system is adjusted as a function of the temperature of the rechargeable battery.

### OBJECT AND ADVANTAGES OF THE INVENTION

The object of the invention is to create an improved method for heating a rechargeable battery. Another object of the invention is to create an improved charger for heating the rechargeable battery. An additional object of the invention is to create an accessory element for heating the rechargeable battery.

One advantage of the above-described method lies in the fact that the rechargeable battery is heated with the aid of an applied voltage, essentially without charging the rechargeable battery. This provides a method with which an excessively cold rechargeable battery is heated before the electrical charging process is started. The above-described method has the advantage of not requiring a change to the mechanical structure of chargers.

In a modification of the invention, the rechargeable battery is discharged further in order to heat it; the discharging current in the rechargeable battery generates heat, which heats the rechargeable battery. This procedure can be used if the rechargeable battery has not yet been excessively discharged, thus permitting further discharging without impairing the function of the rechargeable battery.

In another embodiment, an alternating current is applied to the rechargeable battery so that the rechargeable battery is in fact heated due to the alternating current, but is essentially not charged by it.

In another embodiment, the temperature of the rechargeable battery is detected and the procedure for heating the rechargeable battery is started if the temperature of the rechargeable battery lies below a predetermined threshold. As a result, the method for heating is only used if the temperature of the rechargeable battery is actually insufficient. This avoids unnecessary heating procedures.

In another embodiment, the method for heating the rechargeable battery is discontinued if the temperature of the rechargeable battery lies above a second predetermined threshold. This prevents the rechargeable battery from being heated to an excessive temperature.

The charger according to the invention has the advantage that a heating device is provided for heating the rechargeable battery. It is therefore unnecessary to provide a heating device in the rechargeable battery; instead, the new charger can be used to heat existing rechargeable batteries to the desired temperature before charging.

In another embodiment of the charger, a heating device is provided adjacent to a lateral surface of the charger and the lateral surface is oriented toward a rechargeable battery to be charged. The placement of the heating device on the lateral surface permits good efficiency and therefore a rapid heating of the rechargeable battery.

In another embodiment, the heating device is embodied in the form of a heating plate. The heating plate is inexpensive and easy to manufacture.

In another embodiment, the heating device is embodied in the form of an induction coil that produces eddy currents and therefore heat in the metal parts of the rechargeable battery. The use of the induction coil makes it possible to achieve a contactless heating of the rechargeable battery.

In another embodiment, the charger has an accessory element into which the heating device is built. For example, the accessory element can be embodied in the form of an adapter situated between the charger and the battery. The use of an accessory element has the advantage that the heating device is situated outside the charger and that the heating device is brought close to the rechargeable battery.

Preferably, the accessory element is embodied so that it has additional electrical contacts that are connected to the electrical contacts of the charger.

The accessory element preferably also has an electronic circuit that supplies current or voltage to additional electrical contacts of the accessory element, which are connected to the rechargeable battery, in such a way that the rechargeable battery is first heated and only after being heated, is supplied with the current and voltage for charging the rechargeable battery.

The use of the accessory element has the advantage that it is possible to continue using existing chargers and the additional, new function of heating the rechargeable battery is integrated into the accessory element. For example, the accessory element can also have a sensor for detecting the temperature of the rechargeable battery and can start an initial heating procedure only if the temperature is insufficient for the charging procedure of the rechargeable battery.

In another embodiment, the contact surface of the charger is embodied so that the rechargeable battery is laterally encompassed at least partially on a contact side.

In another embodiment, the accessory element is embodied so that the battery is laterally encompassed at least partially on a contact side. This embodiment permits an improved heat transmission between the accessory element and the rechargeable battery.

### BRIEF DESCRIPTION OF THE DRAWINGS

The invention will be better understood and further advantages thereof will become more apparent from the ensuing detailed description of preferred embodiments taken in conjunction with the drawings, in which:

FIG. 1 is a schematic depiction of a charger and a rechargeable battery;

FIG. 2 is another depiction of a charger with an accessory element and a rechargeable battery;

FIG. 3 is a perspective view of an accessory element;

FIG. 4 is a schematic depiction of another embodiment of an accessory element;

FIG. 5 is a schematic depiction of another embodiment of a charger;

FIG. 6 shows another embodiment of an accessory element; and

FIG. 7 shows an additional embodiment of an accessory element.

### DESCRIPTION OF THE PREFERRED EMBODIMENTS

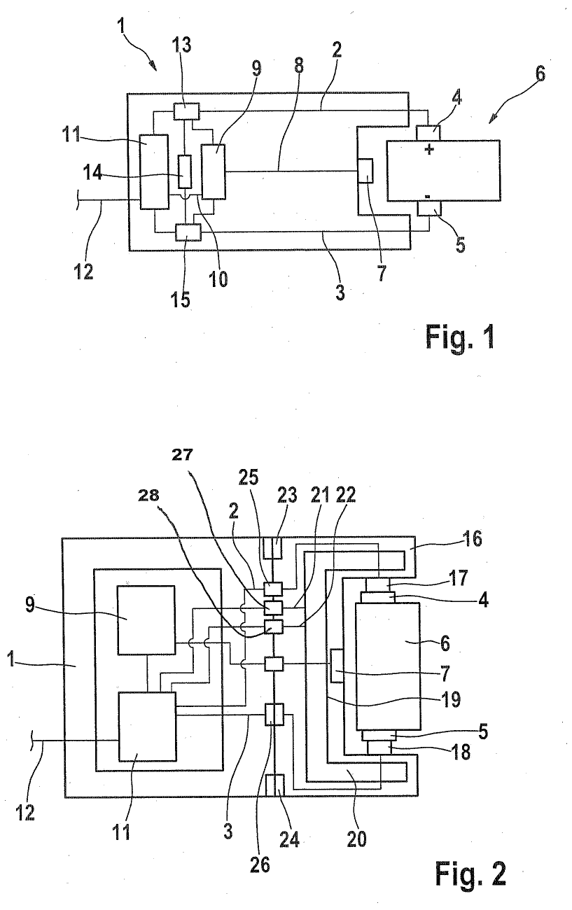

FIG. 1 is a schematic depiction of a charger 1 that is connected via a first and second electrical line 2, 3 to a first and second electrical pole 4, 5 of a rechargeable battery 6. The rechargeable battery 6 can be embodied in the form of an individual rechargeable battery cell or in the form of a battery pack with a plurality of rechargeable battery cells.

In addition, the charger 1 is provided with a temperature sensor 7 that is situated close to the rechargeable battery 6. The temperature sensor 7 detects the temperature of the rechargeable battery 6 and sends the detected temperature via a sensor line 8 to a control unit 9 that is situated in the charger 1. Via a control line 10, the control unit 9 communicates with an electrical circuit 11 that contains a current/voltage source. The electrical circuit 11 can be connected to a power grid via a supply line 12.

The control unit 9 detects the temperature of the rechargeable battery 6 by means of the temperature sensor 7. If the temperature of the rechargeable battery 6 is below a first threshold, for example below 0° C., then the control unit 9 initiates a procedure for heating the rechargeable battery 6 before the start of an electric charging procedure of the rechargeable battery 6. If the temperature of the rechargeable battery 6 reaches an established second threshold that is greater than the first threshold, then the control unit 9 discontinues the procedure for heating the rechargeable battery and starts an electric charging procedure of the rechargeable battery 6. For example, the second threshold can be 15° C.

If the temperature of the rechargeable battery 6 is below the first threshold, then the control unit 9 triggers the electrical circuit 11 so that the rechargeable battery 6 is supplied with voltage and/or current via the first and second electrical lines 2, 3 so that the applied voltage and/or the flowing current heats the rechargeable battery 6, essentially without electrically charging the rechargeable battery 6.

The control unit 9 can select various methods for electrically heating the rechargeable battery 6. A first method is comprised of discharging the rechargeable battery 6 further before the electrical charging. The current supplied by the rechargeable battery 6 during the discharging causes a heating of the rechargeable battery 6. It should be noted, however, that certain rechargeable batteries must not fall below a particular lower voltage limit. But if the voltage level of the rechargeable battery is above the lower voltage limit, then the control unit 9 can connect a load resistor 14 to the electric poles 4, 5 of the rechargeable battery 6 via a first and second switch 13, 15. The control unit 9 is connected to the first and second switch 13, 15 via control lines (not enumerated). The first and second switch 13, 15 here disconnect the electrical circuit 11 from the electrical lines 2, 3 and connect the electrical lines 2, 3 in the charger 1 to each other via the load resistor 14. The dimensions of the load resistor 14 are selected so that a discharge current is initiated that leads to a heating of the rechargeable battery 6. Depending on the selected embodiment, it is also possible to omit a switch 13, 15.

In another embodiment, the control unit 9, with the aid of the electrical circuit 11, applies a predetermined alternating current to the electrical poles 4, 5 of the rechargeable battery 6 in order to heat the rechargeable battery 6. The frequency of the alternating current is selected so that essentially no electrochemical reaction for charging the rechargeable battery 6 is triggered, but instead only a charge exchange of the kind that takes place in a capacitor. The alternating current heats the rechargeable battery 6 without charging the rechargeable battery 6. The frequency of the alternating current can be greater than 50 Hz, typically 1 to 10 kHz. For example, the amplitudes of the voltage of the alternating current are ±100 mV around the potential of the rechargeable battery 6, in particular around the resting potential of the rechargeable battery 6.

The control unit 9 heats the rechargeable battery 6 until the temperature of the rechargeable battery 6 measured by the temperature sensor 7 is above the second threshold. If the temperature of the rechargeable battery 6 exceeds the second threshold, then the control unit 9 discontinues the procedure for heating the rechargeable battery 6 and starts the electrical charging procedure in which the rechargeable battery 6 is electrically charged with the aid of the electrical circuit 11.

FIG. 2 shows another embodiment of a charger 1 that is essentially embodied in accordance with the embodiment of the charger 1 from FIG. 1. In addition, the charger 1 has a charger casing 16 that has a first and second electrical contact 17, 18. The electrical poles 4, 5 of the rechargeable battery 6 are connected to the electrical contacts 17, 18 of the charger casing 16. The first and second electrical contacts 17, 18 are connected to the electrical circuit 11 via the first and second electrical lines 2, 3, respectively. The charger casing 16 has a heating device 20 on a lateral surface 19 oriented toward the rechargeable battery 6. The heating device 20 can be embodied in the form of a resistance wire, a metal foil, or a heating plate. The heating device 20 is connected to the electrical circuit 11 via a third and fourth electrical line 21, 22. Depending on the selected embodiment of the charger casing 16, the charger casing 16 encompasses the rechargeable battery 6 laterally on at least one side with reference to a contact side of the rechargeable battery 6 that is oriented toward the lateral surface 19. Preferably, the heating device 20 is situated parallel to a plurality of lateral surfaces of the charger casing 16 that are oriented toward the rechargeable battery 6.

If the control unit 9, acting in concert with the temperature sensor 7, now detects that the temperature of the rechargeable battery 6 is below the first threshold, then the control unit 9 supplies current to the heating device 20 with the aid of the electrical circuit 11 so that the heating device 20 generates heat. The heating device 20 transmits the heat to the rechargeable battery 6 so that the latter is heated. If the temperature of the rechargeable battery then reaches the second threshold, the control unit 9 discontinues the procedure for heating the rechargeable battery 6 and an electrical charging procedure of the rechargeable battery 6 is started.

Depending on the embodiment selected, the heating device 20 can also be situated on or in the rechargeable battery 6. If the heating device 20 is situated on or in the rechargeable battery 6, then additional corresponding electrical connections are provided for supplying power to the heating device 20 via the charger 1.

In another embodiment, the charger casing 16 can also be embodied as a separate accessory element that is attached to the charger 1 by means of detachable fastening means 23, 24. The first and second fastening means 23, 24 can be embodied in the form of form-locked and/or nonpositive, frictional fastening means. In addition, corresponding contact pairs 25, 26 are provided in order to connect the first and second electrical line 2, 3 from the charger 1 to the corresponding first and second electrical lines 2, 3 of the charger casing 16. Furthermore, additional contact pairs 27, 28 are required in order to connect the corresponding third and fourth electrical lines 21, 22 of the charger 1 to the third and fourth electrical line 21, 22 of the charger casing 16.

Depending on the selected embodiment, the charger casing 16 can have only one heating device 20, with the rechargeable battery 6 being connected to electrical contacts of the charger 1 for the charging. In this embodiment, the charger casing 16 performs only the function of heating the rechargeable battery 6. The electrical supply for the procedure of charging the rechargeable battery 6 is provided by the charger 1. Consequently, the charger 1 has corresponding electrical contacts for contacting the electrical poles 4, 5 of the rechargeable battery 6.

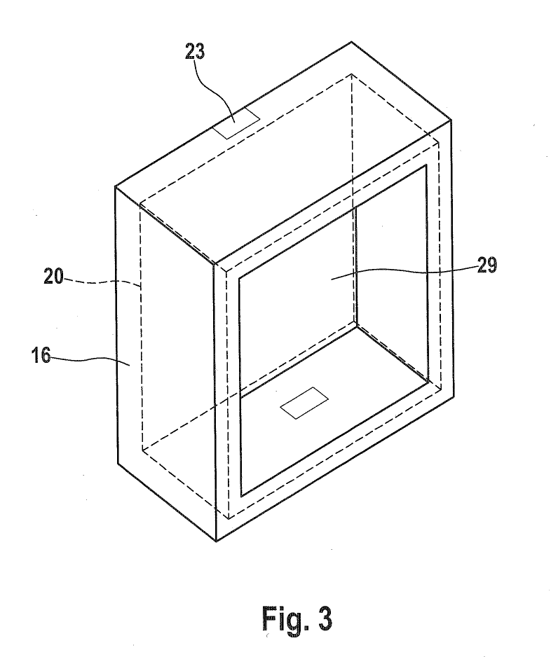

FIG. 3 is a schematic depiction of a charger casing 16. The charger casing 16 can be embodied of one piece with the charger 1 or as a separate component in the form of an accessory element that is attached to the charger 1 by means of a first and second fastening means 23, 24. The charger casing 16 shown in FIG. 3 has a recess 29 that is open at the front of the charger casing 16 and is encompassed on five sides by the charger casing 16. In this embodiment, the heating device 20 is situated, for example, in all five side walls of the charger casing 16. A rechargeable battery 6 inserted into the charger casing 16 is thus encompassed on five sides by the heating device 20. This achieves a quick and efficient heating of the rechargeable battery 6. The heating device 20 is schematically depicted with dashed lines in the side walls of the charger casing 16.

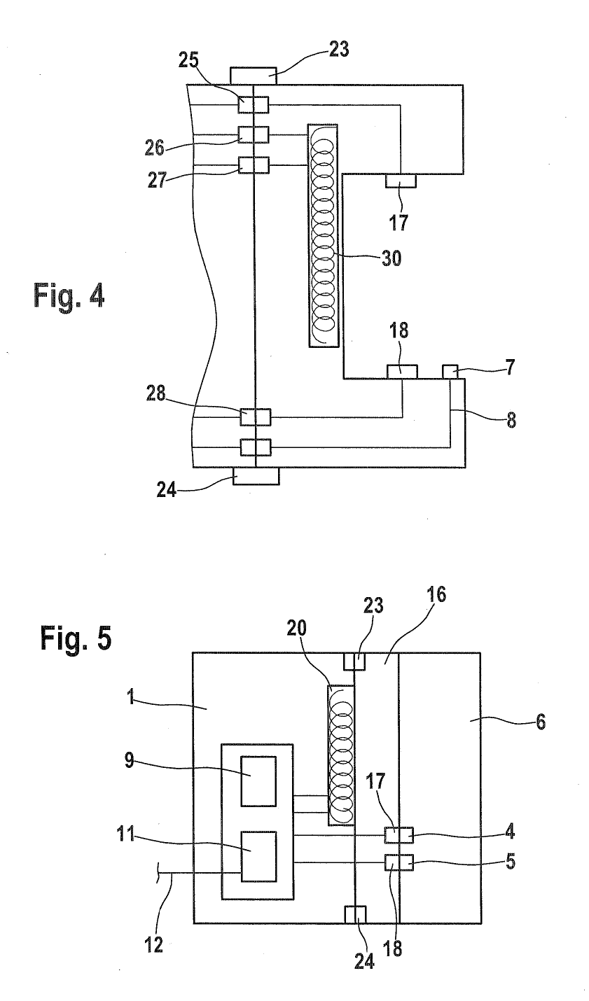

FIG. 4 shows another embodiment, in a subregion of a charger 1 in which a heating device in the form of an induction coil 30 is provided. In this case, it is possible to use alternating currents with a frequency of greater than 100 kHz. When correspondingly actuated by the control unit 9, the induction coil 30 supplies an electromagnetic field to the rechargeable battery 6, in particular to its metallic parts. The electromagnetic field produces eddy currents in metallic parts of the rechargeable battery 6. Due to the electrical resistance in the metallic parts, the eddy currents in turn generate heat that results in the heating of the rechargeable battery 6. The use of the induction coil 30 has the advantage of permitting a contactless heating of the rechargeable battery 6, with a relatively high efficiency.

FIG. 5 is a schematic depiction of another embodiment of a charger 1 in which the charger 1 is equipped with the heating device 20 and is also provided with a charger casing 16, which is embodied of one piece with the charger 1, to accommodate the rechargeable battery 6. The heating device 20 can be embodied, for example, in the form of a heating plate.

Depending on the embodiment used, the different methods for electrically heating the rechargeable battery 6 can be combined with one another. For example, with an appropriate voltage of the rechargeable battery, the rechargeable battery can be discharged further in order to heat the rechargeable battery and only then, electrically heated by means of a corresponding alternating current.

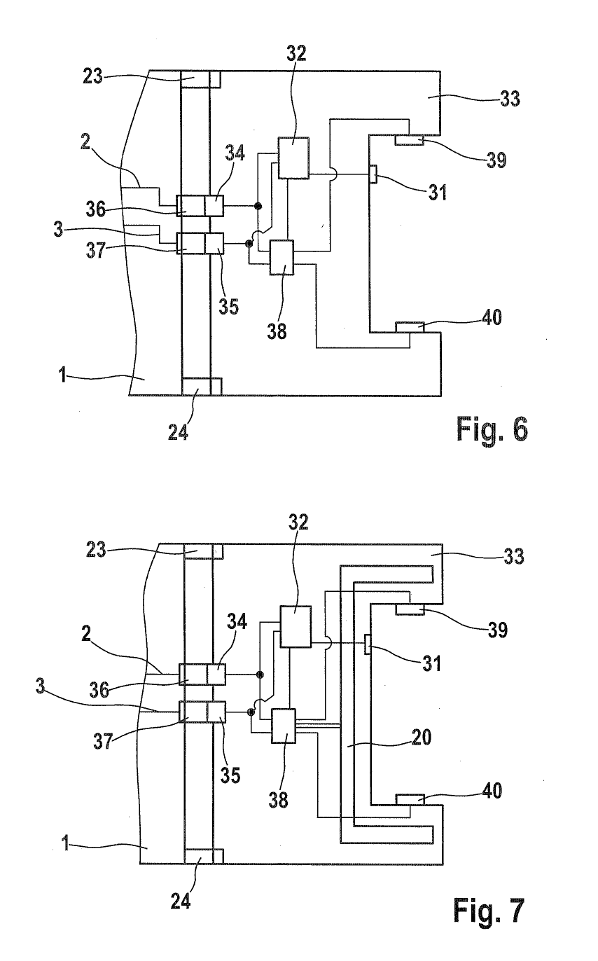

FIG. 6 shows another embodiment of a second charger casing 33 in which the second charger casing 33 is retrofitted to a charger 1. In this case, the charger casing 33 has a second temperature sensor 31, a second control unit 32, and a second electrical circuit 38 that includes a current/voltage source. The second charger casing 33 is connected by additional electrical contacts 34, 35 to electrical contacts 36, 37 of the charger. The first and second electrical contacts 36, 37 of the charger 1 supply current to the second electrical circuit 38 and second control unit 32. The second charger casing 33 in turn has a third and fourth electrical contact 39, 40 to which the electrical poles 4, 5 of the rechargeable battery 6 can be connected. Once again, fastening means 23, 24 are provided with which the second charger casing 33 can be fastened to the charger 1. If a rechargeable battery 6 is connected to the second battery casing 33, then the second control unit 32, working in concert with the second temperature sensor 31, first checks the temperature of the rechargeable battery 6. If the check reveals that the temperature of the rechargeable battery 6 is below the first threshold, then before the rechargeable battery 6 is electrically charged, first a procedure is carried out for heating the rechargeable battery 6. To do so, the second control unit 32 triggers the electrical circuit 38 in a corresponding fashion. In this case, the same procedures are used as have been described in connection with FIG. 1.

If the temperature of the rechargeable battery 6 exceeds the second threshold, then the procedure for heating the rechargeable battery 6 is discontinued and an electrical charging procedure of the rechargeable battery 6 is started. The charging procedure in this case can be carried out, for example, by a second control unit 32, using the second electrical circuit 38. In another embodiment, the electrical charging procedure can be carried out by the charger 1 or more precisely stated, by the control unit 9 of the charger 1. To accomplish this, the second control unit 32 must transmit a corresponding signal to the control unit 9.

FIG. 7 shows another embodiment of a separate charger casing 33 that is essentially embodied in accordance with the embodiment from FIG. 6; in this case, however, a heating device 20 is provided. The second electrical circuit 38 which includes a current/voltage source, supplies the heating device 20 with current. The second control unit 32, working in concert with the second temperature sensor 31, detects the temperature of the rechargeable battery 6 and carries out a procedure for heating the rechargeable battery 6 with the aid of the heating device 20. In this case, procedures are used that have been described in conjunction with examples in FIGS. 2 and 4. For example, the heating device 20 can be embodied in the form of a resistance wire, a metal foil, or a heating plate. In addition, the heating device 20 can be embodied in the form of an induction coil. The rechargeable battery 6 can be heated through a corresponding actuation of the heating device 20, as explained more precisely in the preceding exemplary embodiments. If the second control unit 32 determines that the rechargeable battery 6 has been sufficiently heated, i.e. the temperature of the rechargeable battery 6 is above the second threshold, then the heating procedure is discontinued. Then an electrical charging procedure of the rechargeable battery 6 is carried out. The charging procedure can be carried out either by the second control unit 32 via the second electrical circuit 38 by its current/voltage source or by the charger 1 itself.

The embodiments according to FIGS. 6 and 7 have the advantage that a conventional charger 1 can be retrofitted with a separate charger casing so that a rechargeable battery can be heated before being charged. Consequently, existing chargers can be easily retrofitted.

The foregoing relates to preferred exemplary embodiments of the invention, it being understood that other variants and embodiments thereof are possible within the spirit and scope of the invention, the latter being defined by the appended claims.

1. A method for heating a rechargeable battery, including a step of applying an electric voltage to the rechargeable battery in such a way that current flowing through the rechargeable battery heats the rechargeable battery essentially without charging the rechargeable battery.

2. The method as recited in claim 1, including the step of discharging the rechargeable battery for the heating of the rechargeable battery wherein a discharging current produces heat in the rechargeable battery.

3. The method as recited in claim 1, including the step of applying an alternating current to the rechargeable battery in such a way that the rechargeable battery is heated without an electrical charging of the rechargeable battery.

4. The method as recited in claim 1, including the step of measuring the temperature of the rechargeable battery and initiating the heating of the rechargeable battery if the temperature of the rechargeable battery is below a first threshold.

5. The method as recited in claim 2, including the step of measuring the temperature of the rechargeable battery and initiating the heating of the rechargeable battery if the temperature of the rechargeable battery is below a first threshold.

6. The method as recited in claim 3, including the step of measuring the temperature of the rechargeable battery and initiating the heating of the rechargeable battery if the temperature of the rechargeable battery is below a first threshold.

7. The method as recited in claim 1, including the step of detecting the temperature of the rechargeable battery and discontinuing the heating of the rechargeable battery if the temperature is above a second threshold.

8. The method as recited in claim 2, including the step of detecting the temperature of the rechargeable battery and discontinuing the heating of the rechargeable battery if the temperature is above a second threshold.

9. The method as recited in claim 3, including the step of detecting the temperature of the rechargeable battery and discontinuing the heating of the rechargeable battery if the temperature is above a second threshold.

10. The method as recited in claim 4, including the step of detecting the temperature of the rechargeable battery and discontinuing the heating of the rechargeable battery if the temperature is above a second threshold.

11. The method as recited in claim 5, including the step of detecting the temperature of the rechargeable battery and discontinuing the heating of the rechargeable battery if the temperature is above a second threshold.

12. The method as recited in claim 6, including the step of detecting the temperature of the rechargeable battery and discontinuing the heating of the rechargeable battery if the temperature is above a second threshold.

13. A charger for charging a rechargeable battery, wherein a heating device for heating the rechargeable battery is provided on or in the charger.

14. The charger as recited in claim 13, wherein the heating device is provided adjacent to a lateral surface of the charger that is oriented toward the rechargeable battery.

15. The charger as recited in claim 13, wherein a heating device in the form of an induction coil is provided, which is embodied to produce electromagnetic fields that produce eddy currents in the rechargeable battery, which in turn cause a heating of the rechargeable battery.

16. The charger as recited in claim 14, wherein the heating device laterally encloses the rechargeable battery at least partially.

17. An accessory element, in particular a charger casing equipped with fastening means for attaching the charger casing to a charger for a rechargeable battery, which accessory element is equipped with a heating device.

18. The accessory element as recited in claim 17, wherein the accessory element is embodied in the form of a charger casing that laterally encompasses the rechargeable battery at least partially.

19. An accessory element having fastening means for attaching the accessory element to a charger for a rechargeable battery, haying a temperature sensor for detecting the temperature of the rechargeable battery, having electrical contacts for contacting electrical poles of the rechargeable battery, having a control unit for detecting the signal of the temperature sensor, having a current/voltage source that is connected to the control unit, wherein the current/voltage source is connected to the electrical contacts, the current/voltage source is connected to additional electrical contacts, the additional electrical contacts are provided for connecting to electrical contacts of the charger, and the control unit is embodied to control the current/voltage source so that it supplies a voltage and/or a current to the electrical contacts in order to heat the rechargeable battery.
